(19) United States
(12) Patent Application Publication
(10) Pub. No.: US 2011/0145745 A1
(43) Pub. Date: Jun. 16, 2011

(54) METHOD FOR PROVIDING GUI AND MULTIMEDIA DEVICE USING THE SAME

(75) Inventors: Su-gyeong HYEON, Suwon-si (KR); Yoo-tai KIM, Yongin-si (KR); Dong-heon LEE, Seoul (KR); Hye-young SEONG, Suwon-si (KR); Jung-a KIM, Anyang-si (KR)

(73) Assignee: SAMSUNG ELECTRONICS CO., LTD., Suwon-si (KR)

(21) Appl. No.: 12/902,848

(22) Filed: Oct. 12, 2010

(30) Foreign Application Priority Data
Dec. 14, 2009 (KR) 10-2009-0124104

(51) Int. Cl. G06F 3/048

(52) U.S. Cl. 715/769; 715/772; 715/764

(57) ABSTRACT

A method for providing a graphical user interface (GUI) and a multimedia device using the same, the method including: determining if a user command is input to select a specific section of a GUI item including a plurality of sections; and extending a length of the selected section and reducing lengths of non-selected sections if it is determined that the user command is input to select the specific section of the GUI item. Therefore, the user can manipulate the GUI item more precisely.

### CROSS-REFERENCE TO RELATED APPLICATION

This application claims priority from Korean Patent Application No. 10-2009-0124104, filed on Dec. 14, 2009 in the Korean Intellectual Property Office, the disclosure of which is incorporated herein by reference in its entirety.

### BACKGROUND

1. Field

Apparatuses and methods consistent with the exemplary embodiments relate to a method for providing a graphical user interface (GUI) and a multimedia device using the same, and more particularly, to a method for providing a GUI which receives a user command on a touch screen and a multimedia device using the same.

2. Description of the Related Art

As remarkably developed digital technology is applied to multimedia devices, functions provided by the multimedia devices have increased exponentially. In particular, recently, functions provided by multimedia devices have been provided through items on a screen, taking into consideration an exterior beauty of the multimedia devices and convenience of user access to the multimedia devices.

However, since portable multimedia devices should be made in consideration of convenience of portability, the screen cannot limitlessly become bigger for convenience of manipulation of the user.

In particular, multimedia devices having touch screens are currently a general trend. When a multimedia device having a touch screen is playing back a movie or music, it is difficult for the user to precisely operate the multimedia device using an item which is provided through a small display.

Therefore, when the user wishes to precisely search for content, there is a need for methods for the user to provide a GUI capable of precise operation for a particular section.

### SUMMARY

Exemplary embodiments address at least the above problems and/or disadvantages and other disadvantages not described above. Also, an exemplary embodiment is not required to overcome the disadvantages described above, and an exemplary embodiment may not overcome any of the problems described above.

Apparatuses and methods consistent with the exemplary embodiments relate to a GUI providing method in which, if a specific section of a GUI item is selected, the length of the selected section is extended and the lengths of the non-selected sections are reduced, and a multimedia device using the same.

According to an aspect of an exemplary embodiment, there is provided a method for providing a graphical user interface (GUI), the method including: determining if a user command is input to select a specific section of a GUI item comprising a plurality of sections; and extending a length of the selected section and reducing lengths of non-selected sections if it is determined that the user command is input to select the specific section of the GUI item.

In the extending and reducing operation, the entire length of the GUI item may be maintained and all the sections of the GUI item may be displayed.

In the determining operation, it may be determined if the user command is input through a touch screen.

In the determining operation, if the specific section of the GUI item is touched for greater than a preset period of time, it may be determined that the user command is input to select the specific section of the GUI item, and in the extending and reducing operation, the length of the specific section which is touched for greater than the preset period of time may be extended and the lengths of the non-selected sections may be reduced.

In the determining operation, if the specific section of the GUI item is touched at least twice consecutively, it may be determined that the user command is input to select the specific section of the GUI item, and in the extending and reducing operation, the length of the specific section which is touched at least twice consecutively may be extended and the lengths of the non-selected sections may be reduced.

In the determining operation, if a first section on the GUI item is touched and dragged to a second section on the GUI item, it may be determined that the user command is input to select the first section, the second section, and any section between the first section and the second section on the GUI item, and in the extending and reducing operation, the lengths of the first to second sections may be extended and the lengths of the non-selected sections may be reduced.

In the determining operation, if the GUI item is touched to pass through a first section and a second section, it may be determined that the user command is input to select the first section, the second section, and any section between the first section and the second section on the GUI item, and in the extending and reducing operation, the lengths of the first to second sections may be extended and the lengths of the non-selected sections may be reduced.

The method may further include, after the length of the selected section is extended, determining if a user command is input to extend a reduced section, and extending the length of the reduced section and reducing remaining sections of the plurality of sections other than the reduced section which is extended if it is determined that the user command is input to extend the reduced section.

The GUI item may include at least one of a progress bar, a scroll bar, and a state adjusting bar.

The plurality of sections of the GUI item may be divided in a time unit.

According to an aspect of another exemplary embodiment, there is provided a multimedia device including: an input unit which inputs a user command to select a specific section of a graphical user interface (GUI) item comprising a plurality of sections; and a control unit which extends a length of the selected section and reduces lengths of non-selected sections if it is determined that the user command is input to select the specific section of the GUI item.

The control unit may control the multimedia device so that the entire length of the GUI item is maintained and all the sections of the GUI item are displayed.

The input unit may be a touch screen.

If the specific section of the GUI item is touched for greater than a preset period of time, the control unit may determine that the user command is input to select the specific section of the GUI item so that the length of the specific section which is touched for greater than the preset period of time is extended and the lengths of the non-selected sections are reduced.

If the specific section of the GUI item is touched at least twice consecutively, the control unit may determine that the user command is input to select the specific section of the GUI item so that the length of the specific section which is touched at least twice consecutively is extended and the lengths of the non-selected sections are reduced.

If a first section on the GUI item is touched and dragged to a second section on the GUI item, the control unit may determine that the user command is input to select the first section, the second section, and any section between the first section and the second section on the GUI item so that the lengths of the first to second sections are extended and the lengths of the non-selected sections are reduced.

If the GUI item is touched to pass through a first section and a second section, the control unit may determine that the user command is input to select the first section, the second section, and any section between the first section and the second section on the GUI item so that the lengths of the first to second sections are extended and the lengths of the non-selected sections are reduced.

After the length of the selected section is extended, if a user command is input to extend a reduced section, the control unit may extend the length of the reduced section and reduce lengths of remaining sections other than the reduced section which is selected to be reduced.

The GUI item may include at least one of a progress bar, a scroll bar, and a state adjusting bar.

The plurality of sections of the GUI item may be divided in a time unit.

According to an aspect of another exemplary embodiment, there is provided an apparatus which provides a graphical user interface (GUI) to a display, the apparatus including: an input unit which receives a user command to select a specific section, among a plurality of sections which are currently displayed on the display, of a graphical user interface (GUI) item comprising the plurality of sections; and a control unit which extends a length of the selected section and which reduces lengths of non-selected sections if it is determined that the user command is to select the specific section of the GUI item.

### BRIEF DESCRIPTION OF THE DRAWINGS

The above and/or other aspects will be more apparent by describing certain exemplary embodiments with reference to the accompanying drawings, in which:

FIGS. 1A and 1B illustrate a process of extending a specific section of a progress bar according to an exemplary embodiment;

FIGS. 2A and 2B illustrate another process of extending a specific section of a progress bar according to an exemplary embodiment;

FIGS. 3A and 3B illustrate a process of extending a plurality of specific sections of a progress bar according to an exemplary embodiment;

FIGS. 4A and 4B illustrate another process of extending a plurality of specific sections of a progress bar according to an exemplary embodiment;

FIGS. 5A through 5C illustrate a process of extending a reduced section of a progress bar according to an exemplary embodiment;

FIG. 6 is a block diagram of a multimedia device which provides a graphical user interface (GUI) including a progress bar having an extended section according to an exemplary embodiment; and

FIG. 7 is a flow chart illustrating a GUI providing method according to an exemplary embodiment.

### DETAILED DESCRIPTION OF EXEMPLARY EMBODIMENTS

Certain exemplary embodiments will now be described in greater detail with reference to the accompanying drawings. In the following description, like drawing reference numerals are used for like elements, even in different drawings. The matters defined in the description, such as detailed construction and elements, are provided to assist in a comprehensive understanding of the exemplary embodiments. However, the exemplary embodiments can be practiced without those specifically defined matters. Also, well-known functions or constructions are not described in detail since they would obscure the exemplary embodiments with unnecessary detail. Moreover, expressions such as “at least one of,” when preceding a list of elements, modify the entire list of elements and do not modify the individual elements of the list.

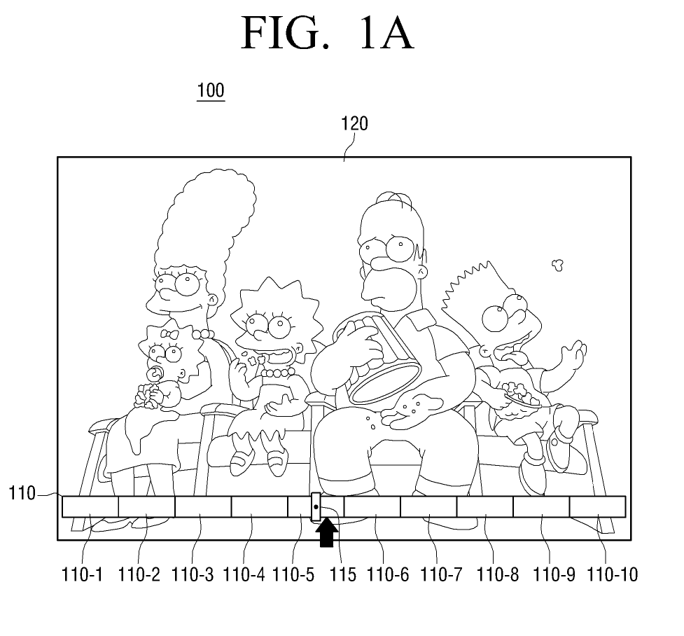

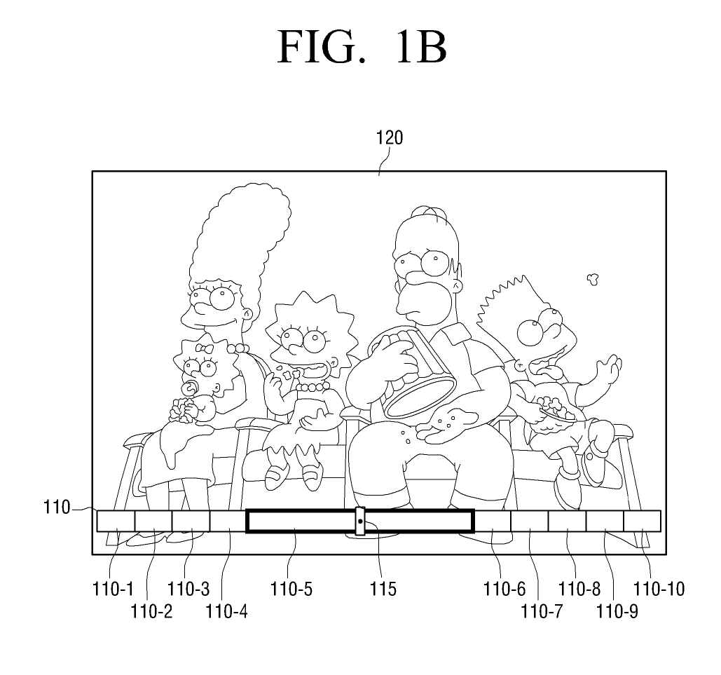

FIG. 1A illustrates a touch screen 100 to display diverse items. The touch screen 100 displays a screen 120 regarding multimedia content currently being displayed, and a progress bar 110 regarding the content.

The screen 120 displays a playback screen of the multimedia content. The multimedia content may include video content such as movies and soap operas, music content, and music content with videos. In this exemplary embodiment, video content or music content with videos are described as an example, such that the touch screen 100 displays video content. However, it is understood that another exemplary embodiment is not limited thereto, and can display the progress bar 110 when music content is played back. In this case, the screen 120 does not provide video.

The progress bar 110 provides position information of currently played-back content. That is, the progress bar 110 provides the user with information regarding a current playback position of content which is played back according to a user command. The position information is displayed distinctly from the remaining positions of the progress bar 110.

In this exemplary embodiment, the progress bar 110 of content has a bar shape having a plurality of sections 110-1, 110-2, . . . , and 110-10. A section indicates the playback time of content divided according to a predetermined basis. For example, if a movie is played back on the screen 120, a section may be a time unit obtained by dividing the entire playback time of the movie according to a predetermined time basis. If still images are sequentially displayed on the screen 120, a section may be a time taken to display a single still image.

A position item 115 indicating a current playback position on the progress bar 110 is expressed by a square block having a point therein in the present exemplary embodiment, though it is understood that another exemplary embodiment is not limited in shape thereto. Accordingly, the current playback position can be distinguished from the remaining positions of the progress bar 110.

The position item 115 can be moved on the progress bar 110 by the user. That is, if the user moves the position item 115 on the progress bar 110, the current playback time point of the content changes and the content is played back from the changed time point.

Moving the position item 115 may be input by touching a desired point on the progress bar 110. That is, the point to which the position item 115 is desired to be moved is a time point at which the user wishes the content is played back.

Hereinafter, among all the sections of the progress bar 110, a method for extending or reducing a specific section of the progress bar 110 so that the user can more precisely select a section desired to play back the content, and the results are described in greater detail with reference to FIGS. 1A through 5C.

FIG. 1A illustrates a method for extending section 110-5 on the progress bar 110 by touching section 110-5 for greater than a predetermined time period (e.g., 3 seconds). As illustrated in FIG. 1A, on the touch screen 100 displaying the progress bar 110, if the user presses section 110-5 of the progress bar 110 for greater than 3 seconds, the length of section 110-5 is extended on the touch screen 100. In contrast, the lengths of the non-selected sections 110-1, . . . , 110-4, 110-6, . . . , and 110-10 are reduced.

FIG. 1B illustrates the extended length of section 110-5 and the reduced lengths of the non-selected sections 110-1, . . . , 110-4, 110-6, . . . , and 110-10 on the progress bar 110 when the user presses section 110-5 on the progress bar 110 for greater than 3 seconds as illustrated in FIG. 1A.

For example, if the entire length of the progress bar 110 is 20 cm, the lengths of all the sections 110-1, . . . , and 110-10 are 2 cm before section 110-5 is extended. However, if a user command is input to extend section 110-5, section 110-5 is extended to 11 cm and the remaining sections 110-1, . . . , 110-4, 110-6, . . . , and 110-10 are reduced to 1 cm. That is, the entire length of the progress bar 110 is maintained and all the sections 110-1, . . . , and 110-10 of the progress bar 110 are displayed, but section 110-5 is extended and the remaining sections 110-1, . . . , 110-4, 110-6, . . . , and 110-10 are reduced. The lengths of the reduced sections 110-1, . . . , 110-4, 110-6, . . . , and 110-10 are the same. In this case, the extended section 110-5 is highlighted to be distinct from the reduced sections 110-1, . . . , 110-4, 110-6, . . . , and 110-10, as illustrated in FIG. 1B, though it is understood that another exemplary embodiment is not limited thereto.

As described above, if a user command is input to extend section 110-5 on the progress bar 110, section 110-5 is extended and the remaining sections 110-1, . . . , 110-4, 110-6, . . . , and 110-10 are reduced, so the user can control the extended section 110-5 of the progress bar 110 more precisely.

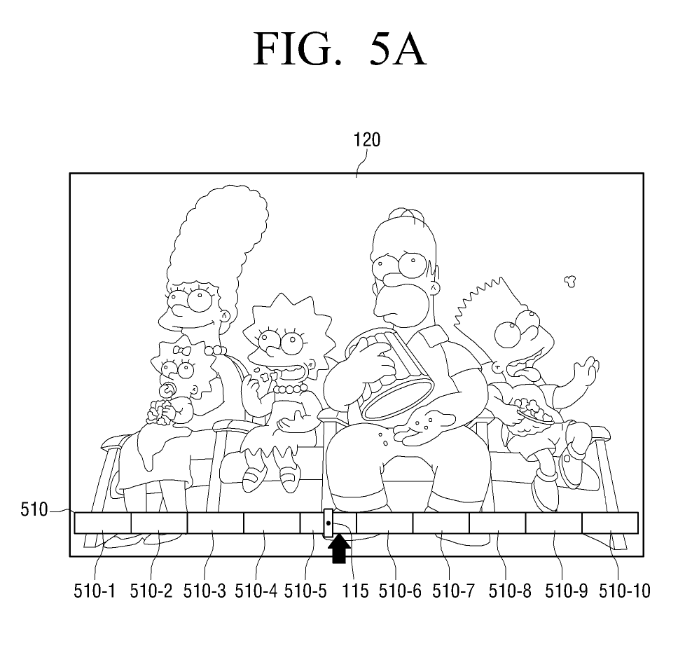

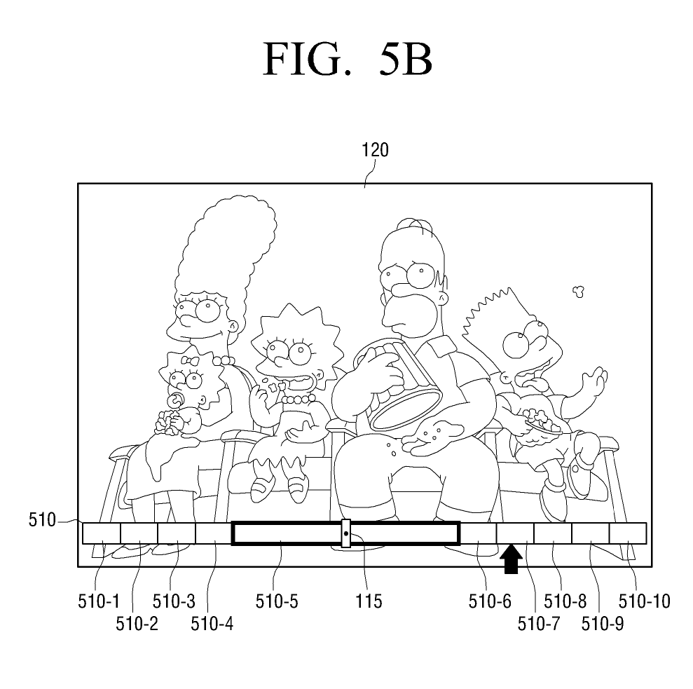

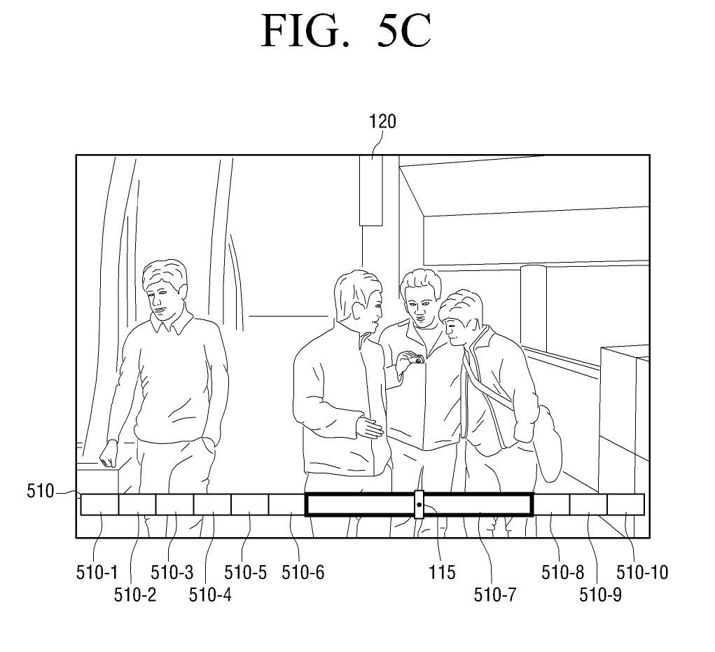

For example, if the entire running time of video content is 1 hour and the progress bar 110 includes 10 sections, a single section has video content of 6 minutes. The extended section 110-5 of 11 cm includes video content of 6 minutes, and each remaining section 110-1, . . . , 110-4, 110-6, . . . , and 110-10 includes content of 6 minutes in 1 cm. Therefore, the user can control playback of the extended section 110-5 with a 5.5 fold increase in precision. Furthermore, the non-selected sections 110-1, . . . , 110-4, 110-6, . . . , and 110-10 do not disappear, so the user can easily search for another section precisely if so desired. This is described later with reference to FIGS. 5A through 5C.

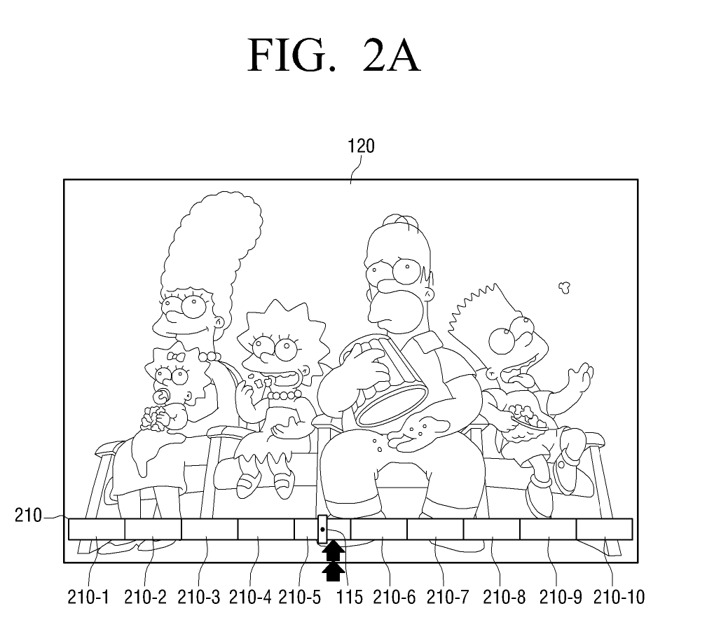

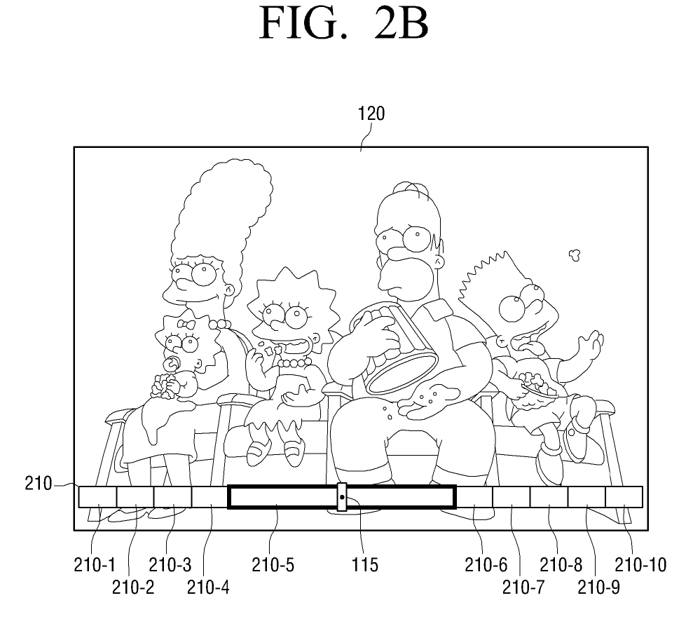

FIG. 2A illustrates a method for extending section 210-5 on a progress bar 210 by touching section 210-5 plural times (e.g., twice) consecutively. As illustrated in FIG. 2A, on the touch screen 100 displaying the progress bar 210, if the user presses section 210-5 of the progress bar 210 twice consecutively, the length of section 210-5 is extended on the touch screen 100. The lengths of the non-selected sections 210-1, . . . , 210-4, 210-6, . . . , and 210-10 are reduced.

FIG. 2B illustrates the extended length of section 210-5 and the reduced lengths of the non-selected sections 210-1, . . . , 210-4, 210-6, . . . , and 210-10 on the progress bar 210 when the user presses section 210-5 on the progress bar 210 twice consecutively as illustrated in FIG. 2A. In this case, the extended section 210-5 is highlighted to be distinct from the reduced sections 210-1, . . . , 210-4, 210-6, . . . , and 210-10, as illustrated in FIG. 2B, though it is understood that another exemplary embodiment is not limited thereto.

That is, when the user touches a specific section twice consecutively, the same result occurs as when the user touches a specific section for greater than 3 seconds in the exemplary embodiment illustrated in FIGS. 1A and 1B.

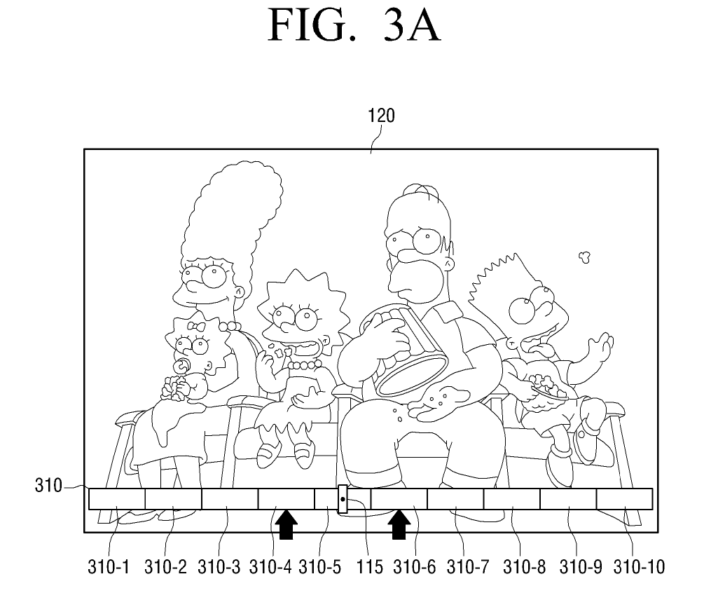

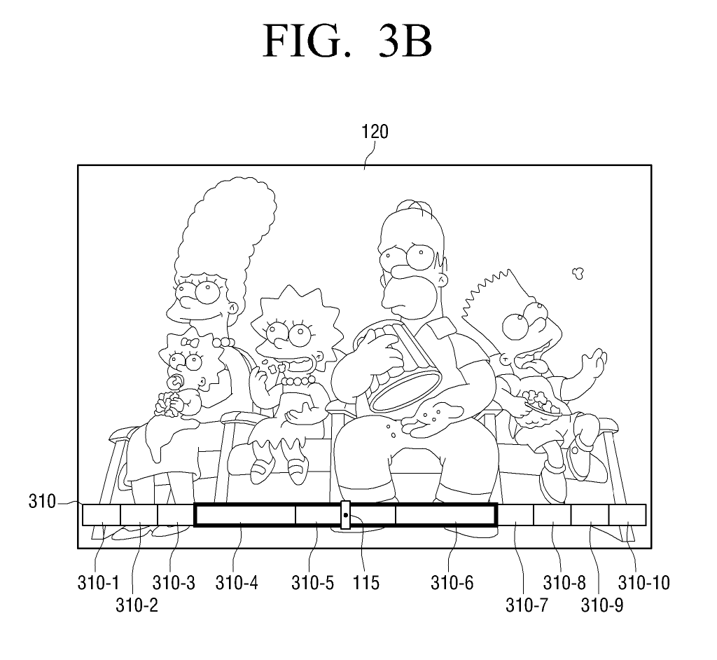

FIG. 3A illustrates a method for extending a plurality of sections 310-4, 310-5, and 310-6 on a progress bar 310 by touching two sections 310-4 and 310-6. Referring to FIG. 3A, if the user selects and touches one section 310-4 and another section 310-6 on the progress bar 310, the selected two sections 310-4 and 310-6 and section 310-5 disposed therebetween are extended. As an example, the two sections 310-4 and 310-6 on the progress bar 310 may be selected by first touching section 310-4 and then dragging the user's finger to section 310-6.

FIG. 3B illustrates the extended length of the selected sections 310-4, 310-5, and 310-6 and the reduced lengths of the non-selected sections 310-1, . . . , 310-3, 310-7, . . . , and 310-10 on the progress bar 310 when the user presses the two sections 310-4 and 310-6 on the progress bar 310 as illustrated in FIG. 3A.

For example, if the entire length of the progress bar 310 is 20 cm, the respective lengths of all the sections 310-1, . . . , and 310-10 are 2 cm before sections 310-4, 310-5, and 310-6 are extended. However, if a user command is input to extend sections 310-4, 310-5, and 310-6, sections 310-4, 310-5, and 310-6 are extended to 13/3 cm and the remaining sections 310-1, . . . , 310-3, 310-7, . . . , and 310-10 are reduced to 1 cm. That is, the entire length of the progress bar 310 is maintained and all the sections 310-1, . . . , and 310-10 of the progress bar 310 are displayed, but the selected sections 310-4, 310-5, and 310-6 are extended and the remaining sections 310-1, . . . , 310-3, 310-7, . . . , and 310-10 are reduced. The lengths of the reduced sections 310-1, . . . , 310-3, 310-7, . . . , and 310-10 are the same. In this case, the extended sections 310-4, 310-5, and 310-6 are highlighted to be distinct from the reduced sections 310-1, . . . , 310-3, 310-7, . . . , and 310-10, as illustrated in FIG. 3B, though it is understood that another exemplary embodiment is not limited thereto.

As described above, if a user command is input to extend the plurality of sections 310-4, 310-5, and 310-6 on the progress bar 310, the plurality of sections 310-4, 310-5, and 310-6 are extended and the remaining sections 310-1, . . . , 310-3, 310-7, . . . , and 310-10 are reduced, so the user can control the extended sections 310-4, 310-5, and 310-6 on the progress bar 110 more precisely. For example, if the entire running time of video content is 1 hour and the progress bar 310 includes 10 sections, a single section has video content of 6 minutes. Each of the extended sections 310-4, 310-5, and 310-6 includes video content of 6 minutes in 13/3 cm, and each of the remaining sections 310-1, . . . , 310-3, 310-7, . . . , and 310-10 includes content of 6 minutes in 1 cm. Therefore, the user can control playback of the extended sections 310-4, 310-5, and 310-6 with an approximately 2.2 fold increase in precision.

In the present exemplary embodiment, three sections 310-4, 310-5, and 310-6 are selected to be extended. However, it is understood that another exemplary embodiment is not limited thereto, and any number of sections may be selected to be extended by touching two sections as described above.

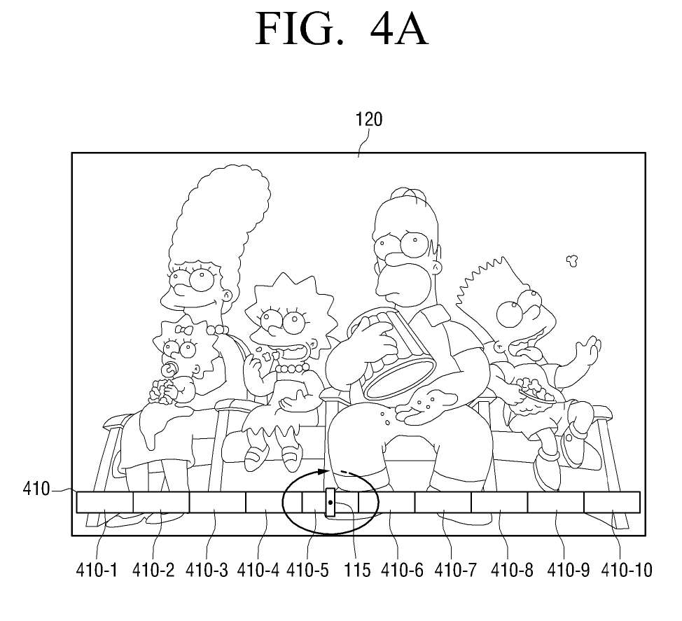

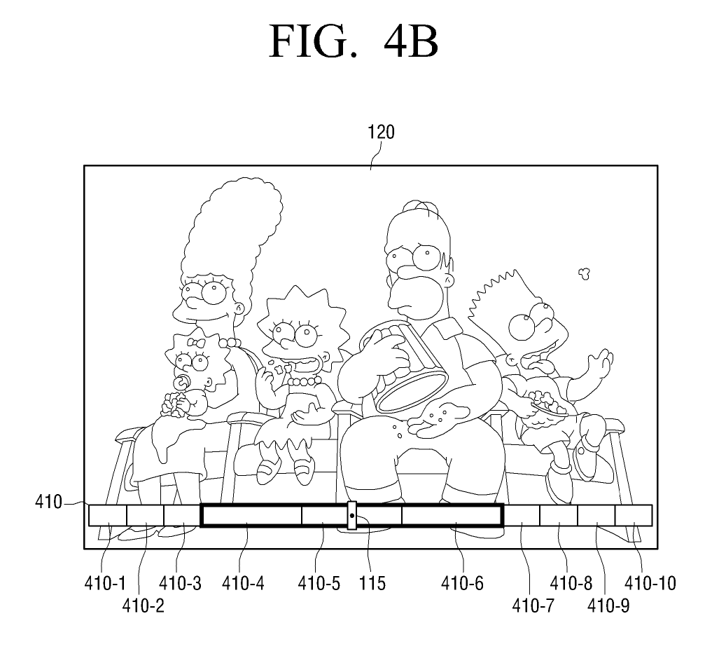

FIG. 4A illustrates a method for extending a plurality of sections 410-4, 410-5, and 410-6 on a progress bar 410 by drawing a circle passing through two sections 410-4 and 410-6.

Referring to FIG. 4A, if the user draws a circle passing through one section 410-4 and another section 410-6 on the progress bar 410, the two sections 410-4 and 410-6 and section 410-5 disposed therebetween are selected. In this case, the two sections 410-4 and 410-6 and section 410-5 disposed therebetween may be selected as long as the user touches the two sections 410-4 and 410-6 even if the user draws a circle.

FIG. 4B illustrates the extended length of the selected sections 410-4, 410-5, and 410-6 and the reduced lengths of the non-selected sections 410-1, . . . , 410-3, 410-7, . . . , and 410-10 on the progress bar 410 when the user selects the three sections 410-4, 410-5, and 410-6 on the progress bar 410 by drawing a circle passing through two sections 410-4 and 410-6, as illustrated in FIG. 4A. In this case, the extended sections 410-4, 410-5, and 410-6 are highlighted to be distinct from the reduced sections 410-1, . . . , 410-3, 410-7, . . . , and 410-10, as illustrated in FIG. 4B.

That is, when the user draws a circle passing through two sections 410-4 and 410-6 on the progress bar 410, the same result occurs as when the user touches two sections 310-4 and 310-6 in the exemplary embodiment illustrated in FIGS. 3A and 3B.

In the present exemplary embodiment, three sections 410-4, 410-5, and 410-6 are selected to be extended. However, it is understood that another exemplary embodiment is not limited thereto, and any number of sections may be selected to be extended by touching two sections as described above.

There are various methods of selecting two sections other than the methods described with reference to FIGS. 3A to 4B. For example, the user may select two sections by touching one section first and then touching another section within a predetermined period of time (for example, one second). In addition, the user may select two sections by touching one section and another section at the same time.

A process of extending a reduced section on a progress bar 510 is described with reference to FIGS. 5A through 5C. FIG. 5A illustrates a method of selecting and extending section 510-5 on the progress bar 510.

As illustrated in FIG. 5A, on the touch screen 100 displaying the progress bar 510, if the user selects section 510-5 of the progress bar 510, the length of section 510-5 is extended on the touch screen 100. The lengths of the non-selected sections 510-1, . . . , 510-4, 510-6, . . . , and 510-10 are reduced. Section 510-5 may be selected in the same manner as described with reference to FIG. 1A or FIG. 2A.

FIG. 5B illustrates the extended length of section 510-5 and the reduced lengths of the non-selected sections 510-1, . . . , 510-4, 510-6, . . . , and 510-10 on the progress bar 510 when the user selects section 510-5 on the progress bar 510 as illustrated in FIG. 5A. In this state, if a user command is input to select reduced section 510-7, the length of reduced section 510-7 is extended and the lengths of the remaining sections 510-1, . . . , 510-6, 510-8, . . . , and 510-10 are reduced.

FIG. 5C illustrates the extended length of section 510-7 and the reduced lengths of the remaining sections 510-1, . . . , 510-6, 510-8, . . . , and 510-10 on the progress bar 510 when the user inputs a command to extend reduced section 510-7 on the progress bar 510 as illustrated in FIG. 5B. In this case, a position item 515 indicating a current playback position is also moved.

As described above, the selected section is extended and the remaining sections are reduced, so all the sections can be displayed. Accordingly, the user can easily and conveniently input a command to extend the reduced section without executing a new progress bar or menu.

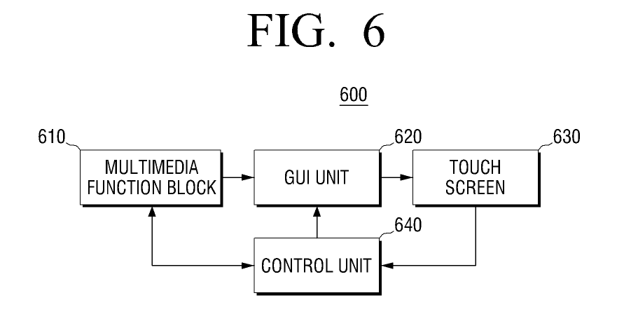

FIG. 6 is a block diagram of a multimedia device 600 which provides a graphical user interface (GUI) including a progress bar 110 having an extended section according to an exemplary embodiment. As illustrated in FIG. 6, the multimedia device 600 may include a multimedia function block 610, a GUI unit 620, a touch screen 630, and a control unit 640.

The multimedia function block 610 performs functions of the multimedia device 600. For example, if the multimedia device 600 is a mobile phone, the multimedia function block 610 can perform a phone function, a short message service (SMS) function, and a content storage/playback function. Similarly, if the multimedia device 600 is an electronic picture frame, the multimedia function block 610 can perform a content (in particular, image content) storage/playback function. In addition, the multimedia function block 610 can perform playback, skip, stop and movement of a playback position of multimedia content.

The GUI unit 620 adds a GUI to an image output from the multimedia function block 610.

The touch screen 630 receives a user's touch and drag inputs, and displays an image to which a GUI is added by the GUI unit 620.

The touch screen 630 receives a command to select one of a plurality of sections on the progress bar 110.

The control unit 640 controls the operation of the multimedia function block 610 according to a user command input through the touch screen 630 or another manipulation method or device (not shown). In addition, the control unit 640 controls the GUI unit 620 to display a GUI corresponding to the user's manipulation on the touch screen 630.

More specifically, if a user command to display the progress bar 110 of content being displayed is input through the touch screen 630, the control unit 640 controls the GUI unit 620 to display the progress bar along with the content. If a user command to play back, stop, or skip content is input through the touch screen 630, the control unit 640 plays back, stops, or skips the content according to the input user command. If the user moves the position of the position item 115 of the progress bar 110 on the touch screen 630, the control unit 640 controls the GUI unit 620 to move the position item 115 to the position touched by the user and controls the multimedia function block 610 to play back the content from the touched position.

In addition, as illustrated in FIGS. 1A through 5C, if a user command is input to extend a specific section of the progress bar 110 on the touch screen 630, the control unit 640 controls the GUI unit 620 to extend the selected section and reduce the non-selected sections. In this state, if the user selects a non-selected section, the control unit 640 controls the GUI unit 620 to extend the newly selected section and reduce the remaining sections.

Furthermore, if a user command is input to extend a specific section of the progress bar 110 on the touch screen 630, the control unit 640 controls the GUI unit 620 to highlight and extend the selected section.

The control unit 640 controls the multimedia device 600 to provide GUIs and functions as illustrated in FIGs. 1A through 5C.

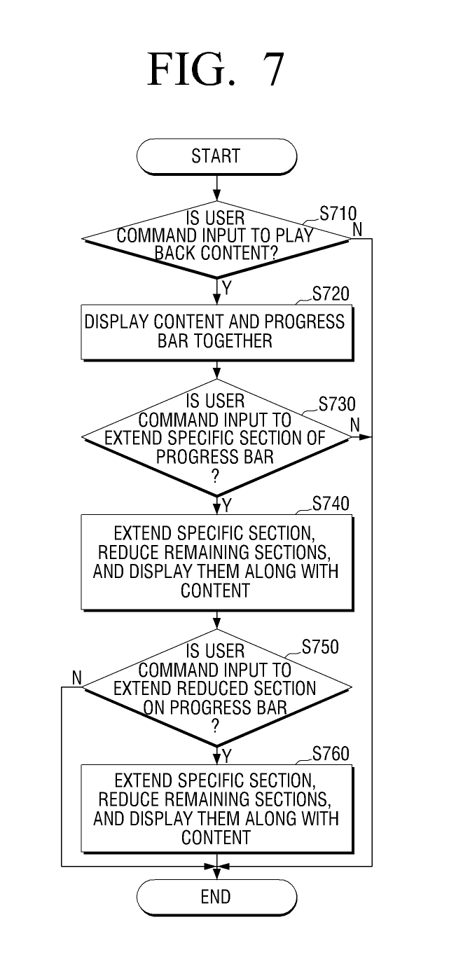

FIG. 7 is a flow chart illustrating a GUI providing method according to an exemplary embodiment. Referring to FIG. 7, the multimedia device determines if a user command is input to play back content (S710).

If the multimedia device determines that a user command is input to play back content (S710-Y), the multimedia device displays the content being played back and the progress bar 110 for the content (S720) on the touch screen 100. The progress bar 110 may be displayed by the user's manipulation.

Subsequently, the multimedia device determines if a user command is input to extend a specific section of the progress bar 110 (S730).

If the multimedia device determines that a user command is input to extend a specific section of the progress bar 110 (S730-Y), the multimedia device extends the specific section of the progress bar 110 and reduces the remaining sections (S740). The progress bar 110 is displayed along with the content. The multimedia device maintains a constant length of the progress bar 110 and displays all of the sections of the progress bar 110.

More specifically, if the entire length of the progress bar 110 is 20 cm, the lengths of the respective sections are 2 cm before a specific section is extended. However, if a user command is input to extend a specific section, the specific section is extended to 11 cm and the remaining sections are respectively reduced to 1 cm. That is, the entire length of the progress bar 110 is maintained and all the sections of the progress bar 110 are displayed, but the specific section is extended and the remaining sections are reduced. The lengths of the reduced sections are the same. In this case, the extended section is highlighted, though it is understood that another exemplary embodiment is not limited thereto.

The multimedia device determines if a user command is input to extend a reduced section (S750).

If the multimedia device determines that a user command is input to extend a reduced section (S750-Y), the multimedia device extends the reduced section selected by the user and reduces the non-selected sections. The progress bar 110 is displayed along with the content (S760). The multimedia device may highlight the extended section.

The multimedia device 600 can provide GUIs and functions as illustrated in FIGs. 1A through 5C. Following this process, the progress bar 110 having an extended section can be provided to the user. As a result, the user can manipulate a desired section of the progress bar 110 more precisely.

In the above exemplary embodiments, a specific section of the progress bar 110 is extended, but this is merely an example. That is, aspects of the exemplary embodiments can be applied even when one or more specific sections of other GUI items are extended. For example, aspects of the exemplary embodiments can be applied when a section of a state adjusting bar or a scroll bar for adjusting a volume or a channel is extended.

In the above exemplary embodiments, a manipulation unit to input a user command to extend a section of the progress bar 110 is implemented as the touch screen 100, but this is merely an example. That is, aspects of the exemplary embodiments can be applied to various manipulation units other than the touch screen 100. For example, the manipulation unit may be implemented as a mouse or a pointing device.

As can be appreciated from the above description, if a specific section of a GUI item is selected, the selected section is extended and the non-selected sections are reduced, so the user can search the selected section more precisely. Furthermore, the non-selected sections do not disappear and all the sections are displayed, so it is possible for the user to extend a reduced section without a separate window or a separate progress bar.

While not restricted thereto, the exemplary embodiments can also be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, the exemplary embodiments may be written as computer programs transmitted over a computer-readable transmission medium, such as a carrier wave, and received and implemented in general-use digital computers that execute the programs. Moreover, while not required in all aspects, one or more units of the multimedia device 600 can include a processor or microprocessor executing a computer program stored in a computer-readable medium, such as a local storage.

The foregoing exemplary embodiments are merely exemplary and are not to be construed as limiting the present invention. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method for providing a graphical user interface (GUI), the method comprising:
determining if a user command is input to select a specific section, among a plurality of sections which are currently displayed, of a GUI item comprising the plurality of sections; and
extending a length of the selected section and reducing lengths of non-selected sections if it is determined that the user command is input to select the specific section of the GUI item.

2. The method according to claim 1, wherein the extending the length of the selected section and reducing the lengths of the non-selected sections comprises maintaining, as compared to prior to the extending the length of the selected section, a total length of the GUI item and displaying all of the plurality of sections of the GUI item.

3. The method according to claim 1, wherein the determining if the user command is input comprises determining if the user command is input through a touch screen.

4. The method according to claim 3, wherein:
the determining if the user command is input through the touch screen comprises, if the specific section of the GUI item is touched for greater than a preset period of time, determining that the user command is input to select the specific section of the GUI item; and
the extending the length of the selected section and reducing the lengths of the non-selected sections comprises extending the length of the specific section which is touched for greater than the preset period of time and reducing the lengths of the non-selected sections.

5. The method according to claim 3, wherein:
the determining if the user command is input through the touch screen comprises, if the specific section of the GUI item is touched at least twice consecutively, determining that the user command is input to select the specific section of the GUI item; and
the extending the length of the selected section and reducing the lengths of the non-selected sections comprises extending the length of the specific section which is touched at least twice consecutively and reducing the lengths of the non-selected sections.

6. The method according to claim 3, wherein:
the determining if the user command is input through the touch screen comprises, if a first section on the GUI item is touched and dragged to a second section on the GUI item, determining that the user command is input to select the first section, the second section, and any section between the first section and the second section on the GUI item; and
the extending the length of the selected section and reducing the lengths of the non-selected sections comprises extending the lengths of the first to second sections, and reducing the lengths of the non-selected sections.

7. The method according to claim 3, wherein:
the determining if the user command is input through the touch screen comprises, if the GUI item is touched to pass through a first section and a second section, determining that the user command is input to select the first section, the second section, and any section between the first section and the second section on the GUI item; and
the extending the length of the selected section and reducing the lengths of the non-selected sections comprises extending the lengths of the first to second sections, and reducing the lengths of the non-selected sections.

8. The method according to claim 1, further comprising:
after the length of the selected section is extended, determining if a user command is input to extend a reduced section; and
extending the length of the reduced section and reducing remaining sections of the plurality of sections other than the reduced section which is extended if it is determined that the user command is input to extend the reduced section.

9. The method according to claim 1, wherein the GUI item comprises at least one of a progress bar of currently reproduced multimedia content, a scroll bar, and a state adjusting bar.

10. The method according to claim 1, wherein the plurality of sections of the GUI item are divided in a time unit.

11. The method according to claim 1, further comprising:
determining if a user command to play back content is input; and
displaying the content and the GUI item if the user command to play back the content is determined to be input.

12. The method according to claim 1, wherein the reduced lengths of the non-selected sections are equal to each other.

13. A computer readable recording medium having recorded thereon a program executable by a computer for performing the method of claim 1.

14. A multimedia device, comprising:
an input unit which inputs a user command to select a specific section, among a plurality of sections which are currently displayed, of a graphical user interface (GUI) item comprising the plurality of sections; and
a control unit which extends a length of the selected section and which reduces lengths of non-selected sections if it is determined that the user command is input to select the specific section of the GUI item.

15. The multimedia device according to claim 14, wherein the control unit maintains, as compared to prior to extending the length of the selected section, a total length of the GUI item and displays all of the plurality of sections of the GUI item.

16. The multimedia device according to claim 14, wherein the input unit is a touch screen.

17. The multimedia device according to claim 16, wherein if the specific section of the GUI item is touched for greater than a preset period of time, the control unit determines that the user command is input to select the specific section of the GUI item so that the length of the specific section which is touched for greater than the preset period of time is extended and the lengths of the non-selected sections are reduced.

18. The multimedia device according to claim 16, wherein if the specific section of the GUI item is touched at least twice consecutively, the control unit determines that the user command is input to select the specific section of the GUI item so that the length of the specific section which is touched at least twice consecutively is extended and the lengths of the non-selected sections are reduced.

19. The multimedia device according to claim 16, wherein if a first section on the GUI item is touched and dragged to a second section on the GUI item, the control unit determines that the user command is input to select the first section, the second section, and any section between the first section and the second section on the GUI item so that the lengths of the first to second sections are extended and the lengths of the non-selected sections are reduced.

20. The multimedia device according to claim 16, wherein if the GUI item is touched to pass through a first section and a second section, the control unit determines that the user command is input to select the first section, the second section, and any section between the first section and the second section on the GUI item so that the lengths of the first to second sections are extended and the lengths of the non-selected sections are reduced.

21. The multimedia device according to claim 14, wherein after the length of the selected section is extended, if a user command is input to extend a reduced section, the control unit extends the length of the reduced section and reduces remaining sections of the plurality of sections other than the reduced section which is extended.

22. The multimedia device according to claim 14, wherein the GUI item comprises at least one of a progress bar, a scroll bar, and a state adjusting bar.

23. The multimedia device according to claim 14, wherein the plurality of sections of the GUI item are divided in a time unit.

24. An apparatus which provides a graphical user interface (GUI) to a display, the apparatus comprising:
an input unit which receives a user command to select a specific section, among a plurality of sections which are currently displayed on the display, of a graphical user interface (GUI) item comprising the plurality of sections; and
a control unit which extends a length of the selected section and which reduces lengths of non-selected sections if it is determined that the user command is to select the specific section of the GUI item.
